(19) United States
(12) Patent Application Publication
(10) Pub. No.: US 2018/0265224 A1
(43) Pub. Date: Sep. 20, 2018

(54) CONCENTRATED SUNLIGHT SPACECRAFT ARCHITECTURE

(71) Applicants: Craig Foulds, Moffett Field, CA (US); Stephen Covey, Moffett Field, CA (US)

(72) Inventors: Craig Foulds, Moffett Field, CA (US); Stephen Covey, Moffett Field, CA (US)

(21) Appl. No.: 15/557,470

(22) PCT Filed: Mar. 11, 2016
(86) PCT No.: PCT/US2016/022131

§ 371 Date: Sep. 11, 2017

Related U.S. Application Data
(60) Provisional application No. 62/131,353, filed on Mar. 11, 2015.

(51) Int. Cl. B64G 1/40; B64G 1/42; B64G 1/10; B64G 1/44

(52) U.S. Cl. CPC B64G 1/402; B64G 1/446; B64G 1/10; B64G 1/427

(57) ABSTRACT

A concentrated sunlight spacecraft architecture system comprising a sunlight concentrator assembly connectively attached to a spacecraft and configured to gather sunlight over a large area and direct the gathered sunlight to a smaller area, an optical waveguide, an optical distributor, and at least one of a plurality of spacecraft subsystems configured to receive and use the gathered sunlight. In an embodiment of the invention, the plurality of the spacecraft subsystems includes a solar thermal propulsion system, a power storage system, and a resource extraction system.

### CROSS REFERENCE TO RELATED APPLICATIONS

The present application is a 371 of PCT/US16/22131 which claims the benefit of and is related to U.S. provisional patent application No. 62/131,353 for “Concentrated Sunlight Spacecraft Architecture” filed on Mar. 11, 2015, the entire contents of which are incorporated herein by reference. The referenced applications are in the names of the same inventors co-owned by the same assignee as the present document.

### FIELD OF THE INVENTION

The present invention relates to spacecraft architecture, in particular, a system that harnesses optically concentrated sunlight to energize multiple subsystems. Sunlight is delivered to these components using optical methods, such as optical waveguides, reflectors, lenses, or by direct exposure to the amplified image.

### BACKGROUND

The use of photovoltaic arrays to power spacecraft electrical systems and subsystems dominates conventional spacecraft architecture. On conventional spacecraft, photovoltaics supply all electrical power, which runs communications, computing, mechanisms, instruments, and in the case of satellites employing electrically-augmented or fully electric propulsion, photovoltaics supply electrical power which accelerates propellant to high velocity. In the latter case, electrical energy is converted into the kinetic energy of the propellant, sometimes with electrostatic or electromagnetic forces, but often through thermal heating.

The sun outputs energy to the Earth at a rate of approximately 1400 watts per meter squared. This energy output is a flux of photons, containing a wide spectral range of visible, infra-red, and ultraviolet wavelengths. When these photons impinge upon photoelectric surfaces, electrical currents are induced at material-specific voltages. This is an electrical power that has been converted from sunlight, albeit at an energy efficiency that is rarely greater than 30%. For a square meter of photovoltaic in space, typically 400 watts of electrical power can be produced, out of the initial 1400 watts. If the intensity of sunlight is increased, say to 14,000 watts per square meter, the equivalent of being very close to the sun, the efficiency of a photovoltaic can increase. At high intensity, a photovoltaic may provide 40%-50% energy efficiency.

The use of photovoltaics in conventional spacecraft architecture also tends to dominate spacecraft surface area, because spacecraft tend to cover all non-instrument surface area with photovoltaics to maximize power. Spacecraft photovoltaic arrays are large, relatively heavy deployable panels of solar cells, substrate (physical medium in which solar cells are fixed), thermal management media, coatings, bundles of power-carrying wire, and the mechanisms and structure which hold the array together and provide nominally sun-pointing orientation. They are designed to minimize mass while being robust to environmental and thermal wear, from incident sunlight (particularly in the UV), particle radiation, and micrometeorites. They are designed to be stowed into a small volume within a launch vehicle, then deploy to cover a large area and generate maximum electrical power.

Spacecraft also employ fixed-body photovoltaics, often in concert with deployed arrays. Fixed-body photovoltaics are typically placed on all surfaces, and in many cases do not provide primary power. Fixed body photovoltaics are often used to ensure that a spacecraft still has some power when in non-ideal orientations, creating at least a small amount of sun-exposed power to keep a spacecraft operational while in non-ideal orientations. Spacecraft are sometimes capable of providing enough power to carry out a mission using only fixed-body panels. This, however, is rarely the case when the power of satellite is proportional to its commercial output (radio power), as is the case with most communication satellites.

Today's satellites are electric, and photovoltaics allows satellites to function without exclusively consuming stored energy. Current satellites are no longer built as in the days of the Soviet Sputnik satellite which was powered exclusively on batteries, nor are they often built and designed like the Voyager satellite which utilizes a nuclear thermal energy source. However, the purely electric satellite has certain design drawbacks. Systems which require high temperature provide electrical heating, which means that energy from the sun, which can be directly converted into heat, is instead converted into electricity and then heat. This is a power inefficiency due to the energy loss in the conversion. Meanwhile, spacecraft that generate useful photons (i.e. all spacecraft with radios) are fundamentally converting solar photons into generated photons through electrical stages. Certainly some power efficiencies improve when higher power is used, but still, the higher-power the system, the more power is lost.

Spacecraft employing photovoltaics tend to have a certain, regular structure to them. So regular in fact, that elements of it are not typically acknowledged as being design principles at all. Most obviously, photovoltaic spacecraft are commonly covered with photovoltaics. They have high-powered radios, and complex thermal management systems. The solar cells and other electronics are radiation hardened, and protected against the space environment. They store their energy in batteries, occasionally fuel cells or even flywheels. The spacecraft is sensitive to, but protected against differential charging (commonly caused by charged particles in the space environment, but also be unsolicited photoelectric effects). Obvious to the point of appearing absurd, these spacecraft send power (and data) between subsystems using electrically conductive wires. This set of conventional spacecraft design principles both enables the modern conception of spacecraft systems, while it quietly makes certain spacecraft technologies difficult or unreasonable to implement.

It is therefore preferred that a system does not necessarily require and is not structurally dominated by photovoltaic arrays. Rather, using a system to concentrate sunlight for use directly in spacecraft subsystems allows greater efficiency in the total power generation per mass of the spacecraft. Utilizing concentrated sunlight can generate greater power for spacecraft systems because of both the stowability of deployable optical concentrators and the increased power efficiency of spectrally-efficient collectors in concert with high intensity photovoltaics when electrical power is needed. Gathering concentrated sunlight can further increase power generation per mass by the increased thermal power efficiency of thermally driven subsystems when solar photons are directly converted into heat instead of photons converting to electricity and then electricity to thermal power. A spacecraft can be more power-efficient than conventional spacecraft by being comprised of subsystems which are non-electric, specifically when they utilize concentrated sunlight directly. Therefore, it is preferred to use a spacecraft system that captures concentrated sunlight in conjunction with thermally driven spacecraft subsystems to ensure optimal efficiency.

### SUMMARY OF THE INVENTION

In general, in one aspect, the invention relates to a concentrated sunlight spacecraft architecture system. The system comprises a sunlight concentrator connectively attached to a spacecraft and configured to gather sunlight over a large area and direct the gathered sunlight to a smaller area, an optical waveguide, an optical distributor, and at least one of a plurality of spacecraft subsystems configured to receive and use the gathered sunlight. In an embodiment of the invention, the plurality of the spacecraft subsystems includes a solar thermal propulsion system, a power storage system, and a resource extraction system.

Novel features include concentrating gathered sunlight for direct use in spacecraft subsystems. Because the spacecraft subsystems are designed to receive the solar energy rather than using solar power that has been converted into electricity greater efficiency in the total power generation is attained. Further, a design priority is given to subsystems rather than the conventional solar-powered spacecraft exterior as sunlight is delivered directly to the subsystems allowing increased energy intensity input and reduction in size due to operational efficiency. Potential applications of CSSA are particularly novel as intense sunlight is not conventionally used on spacecraft within individual subsystems. These applications extend beyond the primary purpose of architecture, which is concentrating sunlight, and is demonstrative of the high utility of this spacecraft architecture.

### BRIEF DESCRIPTION OF THE DRAWINGS

These and other features and advantages of the present invention will be better understood by reading the following Detailed Description, taken together with the Drawings wherein:

FIG. 1 is a diagram of one embodiment of the present invention.

FIG. 2 is a partial diagram of an alternate embodiment of the present invention.

FIG. 3 is a partial diagram of a further alternate embodiment of the present invention.

FIG. 4 is a partial diagram of a further alternate embodiment of the present invention.

### DETAILED DESCRIPTION OF THE PREFERRED EMBODIMENTS

Specific embodiments of the invention will now be described in detail with reference to the accompanying figures. Like elements in the various figures are denoted by like reference numerals for consistency. In the following detailed description of embodiments of the invention, numerous specific details are set forth in order to provide a more thorough understanding of the invention. However, it will be apparent to one of ordinary skill in the art that the invention may be practiced without these specific details to avoid unnecessarily complicating the description.

In general, embodiments of the invention provide a system for a concentrated sunlight spacecraft architecture. A solar collector assembly is configured to gather sunlight guiding it in a concentrated manner to an optical distributor where the concentrated sunlight is directed to a plurality of spacecraft subsystems including a solar thermal propulsion system, a power storage system, and resource extraction system.

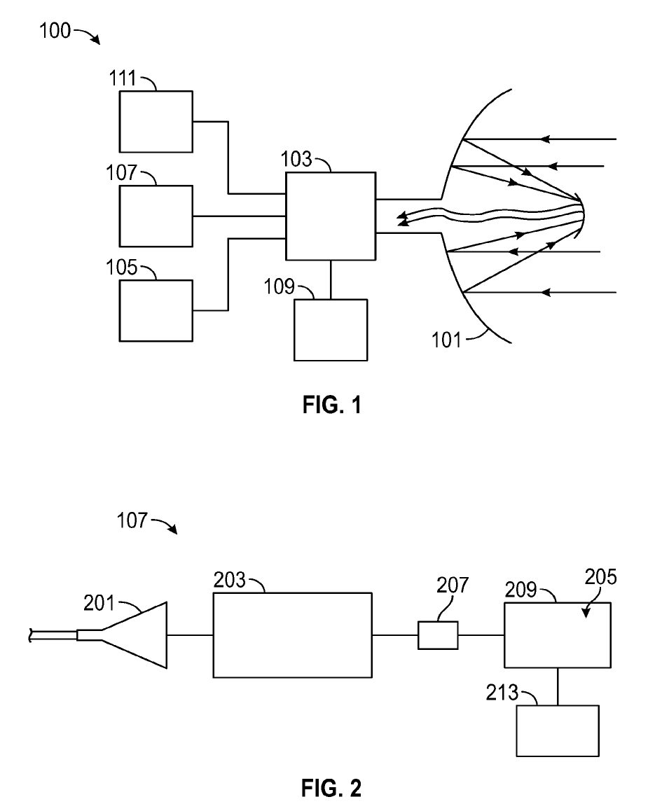

The embodiment of FIG. 1 provides a diagram of an embodiment of a concentrated sunlight spacecraft architecture (CSSA), generally designated by reference numeral 100, according to the principles of the present invention. The CSSA 100 includes a solar collector assembly 101, an optical switch 103, a concentrated solar power storage system 105, a solar thermal propulsion system 107, a thermo-optical subsystems management system 109, and a solar thermal resource extraction management system 111. In this embodiment of the invention, sunlight 113 is directed towards the solar collector assembly 101 where it is concentrated and directed to the optical switch 103. The optical switch 103 is configured to distribute the sunlight to at least one of a plurality of thermal optical spacecraft systems. In this embodiment of the invention, the plurality of spacecraft systems includes the solar thermal propulsion system 107, the thermo-optical subsystems management system 109 and the solar thermal resource extraction management system 111. The thermo-optical subsystems management system 109 is configured to direct solar energy to a plurality of spacecraft subsystems including but not limited to illumination, spacecraft thermal control, thermo-mechanical mechanisms, thermo-mechanical power, thermal energy storage, and resource processing. In an embodiment of the invention, the optical switch 103 is further configured to direct the sunlight to a concentrated solar power storage system 105. In a further embodiment of the invention, the optical switch 103 is still further configured to project light away from the CSSA 100 and out into space.

The solar collector assembly 101 is a collection device configured to gather sunlight and concentrate the sunlight into a smaller beam of solar energy. The solar collector assembly includes a primary reflector configured to reflect sunlight onto a smaller secondary reflector. The primary reflector can be any device that can reflect sunlight including a Fresnel lens, a parabolic mirror, a Fresnel reflector, a parabolic lens, a solar trough, or refractive optics. In an embodiment of the invention, the solar collector assembly 101 is attached onto the exterior of the spacecraft that is in a cruising stage. In an embodiment of the invention, the solar collector assembly 101 is essentially stationary but can directionally move to different focal points in order most efficiently capture sunlight. In an embodiment of the invention, a collector gimbal allows rotation of the solar collector assembly 101 to ensure efficiency in harnessing sunlight. In an embodiment, a user may operationally control the direction of the solar collector assembly 101. In an embodiment of the invention the solar collector assembly 101 includes a collector deployment mechanism allowing the solar collector assembly 101 to be deployed once the spacecraft is at a target destination or in a cruising stage. In an embodiment of the invention, the deployment mechanism includes the dense packing of a solar collection area to minimize stowed volume and dimensions. In an alternate embodiment of the invention, the solar collection assembly 101 can be segmented in such way that the deployed structure consists of many small sections that cover a large area when deployed. In another alternate embodiment of the invention, the solar collector assembly is further configured to serve as a communications dish or reflector or signal repeater. In a further alternate embodiment of the invention, the solar collector assembly is configured to receive and magnify images using unconventionally large optics, which may be deployable. In a further alternate embodiment of the invention, the solar collector assembly is further configured to act as a structural chassis for other spacecraft components. In a yet alternate embodiment of the invention, the solar collector assembly is configured to be a sun shade for sensitive instruments.

A primary reflector is configured to receive sunlight and reflect the sunlight towards a secondary reflector centrally positioned in front of the primary reflector. The secondary reflector is smaller than the primary reflector and reflects the received sunlight towards an optical input point concentrating all of the sunlight received by the primary reflector into a smaller area. In an embodiment of the invention the secondary reflector is a convex mirror. An optical input point, according to an embodiment of the invention, is configured to concentrate the inputted sunlight and release it through an output. The optical input point is larger than the expected solar image size by at least a sufficient diameter such that the minimum angular error in spacecraft attitude control and gimbal accuracy does not cause concentrated sunlight to miss the optical input point. An optical waveguide tunnel directs the concentrated sunlight to the optical switch 103 and may comprise optical fiber or light pipes.

FIG. 2 provides a block diagram of the solar thermal propulsion (STP) system 107. The STP system 107 is configured to provide the CSSA 100 with propulsion using direct solar power. The STP system 107 comprises a nozzle 201 connected to a heat exchanger 203. In an embodiment of the invention, the heat exchanger 203 is configured receive concentrated sunlight and to allow the concentrated solar energy to be exchanged to a propellant 205 thereby increasing the temperature of the propellant 205. The propellant 205 can be any one of several propellant types including but not limited to carbon dioxide, water, waste water, ammonia, hydrazine, mono methyl hydrazine, unsymmetrical dimethylhydrazine, and water with soluble additives such as salts or alcohol. Furthermore, in an alternate embodiment of the invention, the propellant 205 may be a gas rather than a liquid. The STP system 107 is configured to be effectively chemistry-agnostic compared to conventional propulsion systems, where propellant without chemical severity to the system is utilized. In an embodiment of the invention, a single spacecraft thruster using the STP system 107 can exploit several different types of propellants. In an embodiment of the invention, the STP system 107 may be optimized to run a single propellant.

The heat exchanger 203 is further connected to a valve 207 that is connected to a propellant feed tank 209. In an embodiment of the invention a pump 211 is disposed between the valve 207 and the propellant feed tank 209. In an embodiment of the invention a refill tank 213 is connected to the propellant feed tank 209. All of the components comprising the STP system 107 are made out of materials that remain structural above 150 degrees Celsius, and all of which may be in conductive thermal contact and may be externally heated by concentrated solar radiation. In an embodiment of the invention, the STP system 107 is configured to allow concentrated solar energy to be exchanged to a propellant 205 housed in the propellant feed tank 209 through the housing of the propellant feed tank 209 to increase the temperature of the propellant 205. In an embodiment of the invention, thermal insulation is used to keep the thruster at high temperature when desired, and to avoid and prevent sensitive spacecraft systems and subsystems from overheating.

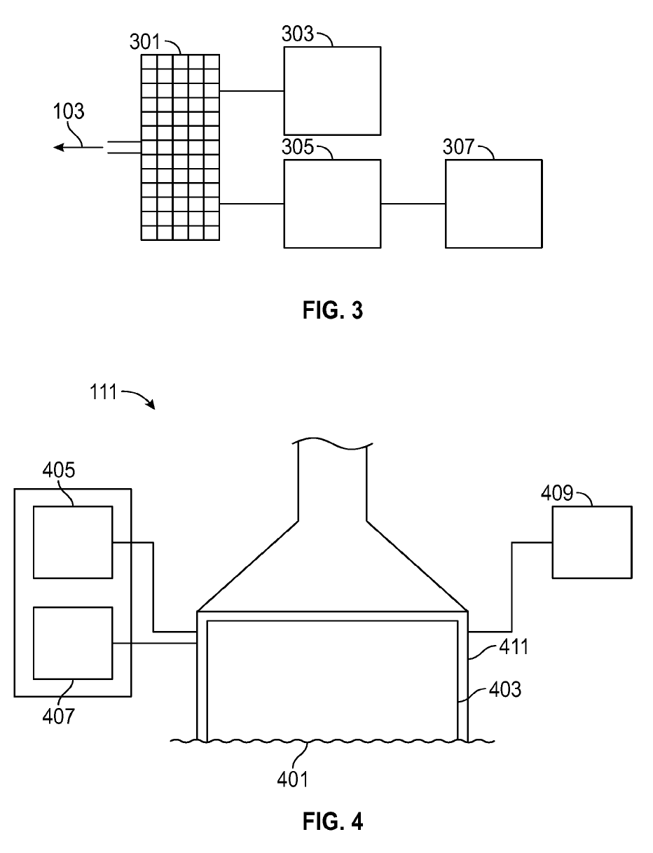

FIG. 3 provides a detailed block diagram of the concentrated solar power storage system 105. A plurality of photovoltaic cells 301 receive concentrated sunlight from the optical switch 103 and convert the concentrated sunlight into electricity. The plurality of photovoltaic cells 301 are connected to a radiator 303 and an electrical power subsystem 305. The electrical power subsystem 305 is configured to provide electrical power to the spacecraft and any payload subsystems or components. The electrical power subsystem 305 is connected a storage unit 307 for energy storage when concentrated sunlight may not be readily available such as during a solar eclipse. In an embodiment of the invention, the electrical power subsystem 305 is further configured to control and regulate power distribution and ensure that the storage unit 307 does not overcharge or overheat. The storage unit 307 may be any type of battery suitable for spacecraft power systems including but not limited to lithium carbon monofluoride, lithium sulfur diode, silver zinc, nickel cadmium, nickel hydrogen, or lithium thionyl chloride. In an embodiment of the invention, the storage unit 307 comprises a plurality of batteries.

FIG. 4 provides a diagram of the solar thermal resource extraction management system 111. The solar thermal resource extraction management system 111 is configured to mine an asteroid surface or a portion of an asteroid and extract resources from the mined material. One way of extracting volatile elements from an asteroid is to use heat. In an embodiment of the invention, concentrated sunlight is used to perform mining functions on an asteroid surface 401 using a thermal mass 403. In this embodiment, concentrated sunlight having a high temperature is applied to the thermal mass 403 which is configured to absorb nearly all of the heat from the concentrated sunlight. The thermal mass 403 is applied to the asteroid surface 401 heating the asteroid surface until volatile elements melt and are released in a gaseous state. In an alternate embodiment of the invention, the thermal mass may be applied to an already mined piece of an asteroid. In general, such a method of mining is used on c-type spectral asteroids because this spectral type has volatile elements that can be most efficiently mined with heat. The thermal mass 403 may be any material that can absorb heat at a high temperature, generally above 500 degrees Celsius, such as steel and will reflect very little of the concentrated sunlight. This method is an effective way to mine resources from an asteroid because an asteroid will reflect much of the heat from the concentrated sunlight rather than absorbing it. A steam absorption unit 405 collects any steam that is released from the application of the concentrated sunlight and a wicking unit 407 is configured to absorb any recondensation fluids or liquids resulting from the mining process. A mined elements chamber 409 provides a means for capturing gaseous minerals from the mining process and a rigid insulator 411 provides a chasis that allows the thermal mass 403 to maintain its heat for a prolonged period of time.

While the principles of the invention have been described herein, it is to be understood by those skilled in the art that this description is made only by way of example and not as a limitation as to the scope of the invention. Further embodiments are contemplated within the scope of the present invention in addition to the exemplary embodiments shown and described herein. Modifications and substitutions by one of ordinary skill in the art are considered to be within the scope of the present invention, which is not to be limited except by the following claims.

What is claimed is:

1. A concentrated sunlight architecture system for a spacecraft, comprising:
a spacecraft having an exterior surface;
a sunlight concentrator assembly fixedly attached to said surface of said spacecraft;
an optical waveguide tunnel;
an optical distributor; and
at least one of a plurality of spacecraft subsystems configured to receive and use concentrated sunlight.

2. The concentrated sunlight architecture system for a spacecraft of claim 1, wherein said sunlight concentrator assembly is rotatable along an axis planar to said exterior surface of said spacecraft.

3. The concentrated sunlight architecture system for a spacecraft of claim 1, wherein said at least one of a plurality of spacecraft subsystems configured to receive and use concentrated sunlight comprises a solar thermal propulsion system.

4. The concentrated sunlight architecture system for a spacecraft of claim 1, wherein said at least one of a plurality of spacecraft subsystems configured to receive and use concentrated sunlight comprises a solar-electrical power storage system.

5. The concentrated sunlight architecture system for a spacecraft of claim 1, wherein said at least one of a plurality of spacecraft subsystems configured to receive and use concentrated sunlight comprises a space object resource extraction system.

6. The concentrated sunlight architecture system for a spacecraft of claim 1, wherein said sunlight concentrator assembly comprises:
a primary reflector configured to reflect sunlight towards a primary central focal point;
a secondary reflector centrally disposed in front of said primary reflector and configured to reflect said sunlight directed towards said primary central focal point onto a secondary focal point; and
an optical input point configured to receive said sunlight directed onto said secondary focal point.

7. The concentrated sunlight architecture system for a spacecraft of claim 3, wherein said solar thermal propulsion system comprises:
a nozzle;
a heat exchanger; and
a propellant tank housing spacecraft propellant,
wherein said heat exchanger is configured to receive concentrated sunlight and transfer heat from said concentrated sunlight to said propellant tank heating said propellant.

8. The concentrated sunlight architecture system for a spacecraft of claim 5, wherein said space object resource extraction system comprises:
a thermal mass applied to a mining surface of a space object;
a steam absorption unit;
a wicking unit;
a mined elements chamber; and
a rigid insulator,
wherein said thermal mass absorbs an amount of concentrated sunlight heating said thermal mass and wherein said thermal mass is applied to said mining surface heating said mining surface until said mining surface releases mineral elements.
